(19) United States
(12) Patent Application Publication
(10) Pub. No.: US 2004/0120341 A1
(43) Pub. Date: Jun. 24, 2004

(54) Method for dynamically managing SCO links in bluetooth system

(76) Inventors: Jeen Hur, Daejon (KR); Sungback Hong, Daejon (KR); Byung-Jo Kim, Daejon (KR); Hoo-Sung Lee, Daejon (KR); Sun-Hee Kim, Daejon (KR); Seong-Su Park, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/733,923

(22) Filed: Dec. 10, 2003

(30) Foreign Application Priority Data
Dec. 21, 2002 (KR) 2002-82205

(51) Int. Cl. H04B 7/212

(52) U.S. Cl. 370/442; 370/389

(57) ABSTRACT

The present invention provides a method for managing SCO links dynamically in a Bluetooth system, which can reduces energy consumption in a Bluetooth system and provides better quality of data transmission by managing synchronous connection-oriented (SCO) links according to channel environment. The method includes the steps of: (a) analyzing communication channels in order to secure a quality of data transmission in the Bluetooth system; and (b) changing types of SCO links according to the channel analysis.

### FIELD OF THE INVENTION

The present invention is related to a method for managing synchronous connection-oriented (SCO) links in a Bluetooth system; and, more particularly, to a method for managing SCO links in a Bluetooth system by adding additional SCO links according to channel environment and a computer readable recording medium storing a program for executing the same method.

### PRIOR ART OF THE INVENTION

Bluetooth is a protocol for transmitting and receiving data between electronic devices by using wireless frequency in a short-range. According to Bluetooth, two terminals recognize each others, establish a link and transmit/receive the data in the short range.

FIG. 1 is a table showing types of synchronous connection-oriented (SCO) links of Bluetooth.

Referring to FIG. 1, type I to III are the SCO links of the conventional Bluetooth protocol. Type IV to VI are the SCO links in accordance with the present invention.

Bluetooth standard provides three kinds of SCO links. These links are characterized by a kind of packet and a magnitude of data as shown in FIG. 1. Type III has a long transmission interval but is sensitive to error. On the contrary, type I has a short transmission interval but is not sensitive to the error. Mean data transfer rate of 64 Kbps is required for real-time transmission of uncompressed voice data and these three types of links satisfy the requirement of data transfer rate.

FIG. 2 is a diagram showing a conventional Bluetooth system. According to the conventional Bluetooth standard, each Bluetooth device can have one SCO link and the type of SCO link is type II or type III symmetrically.

Referring to FIG. 2, the conventional Bluetooth system includes a user terminal 8 such as wireless headset, a relay station 7 such as Bluetooth telephone and a base station 9 such as an access point.

The user terminal communicates with the base station through the relay-station in real time.

As shown in FIG. 2, two SCO links are required. According to the convention Bluetooth standard, two SCO links must be same type such as type II or type III. The type of SCO link is determined by analyzing channel environment. When data loss is predicted by bad channel environment, type II is applied. In other cases, type III is applied.

FIGS. 4A and 4B are diagrams showing usages used time slots in a Bluetooth system. FIG. 4A shows timeslots used in type II link and FIG. 4B shows timeslots used in type III link.

The problem of the conventional art is that the channel environment is not considered for choosing a type of SCO link. Referring to FIG. 2, a distance between the user terminal and the relay station SCO link 2 is even closer than a distance between the relay station and the base station SCO link 1. Therefore, the interference between the user terminal and the relay station SCO link 2 is smaller than the interference between the relay station and the base station SCO link 1.

However, according to the conventional Bluetooth protocol, the type of two SCO links must to be same even in case that the interference of SCO links II is much larger than the interference of SCO link I. If type II is chosen for the above mentioned case, the unnecessary slot of link 2 is wasted. If type III is chosen, the quality of the link 1 is not satisfied.

Although a dynamic algorithm for choosing adequate packet in an asynchronous connection-less (ACL) link has been developed, a dynamic algorithm for choosing adequate type of link has not been disclosed yet.

### SUMMARY OF THE INVENTION

Therefore, it is an object of the present invention to provide a method for managing synchronous connection-oriented (SCO) links among more than two Bluetooth devices by adding additional SCO links according to channel environment, and a computer readable recording medium for executing the same method.

In accordance with an aspect of the present invention, there is provided a method for dynamically and asymmetrically managing synchronous connection-oriented (SCO) links in a Bluetooth system, including the steps of: (a) analyzing a quality of communication channels in the Bluetooth system; and (b) dynamically changing types of each of SCO links according to the channel analysis.

In accordance with another aspect of the present invention, there is provided a computer readable recording medium for recording a program that implements a method for managing SCO links in a Bluetooth system including a microprocessor, the method including the steps of: (a) analyzing a quality of data communication channels in the Bluetooth system; and (b) changing types of each of SCO links according to the channel analysis.

### BRIEF DESCRIPTION OF THE DRAWINGS

The above and other objects and features of the present invention will become apparent from the following description of preferred embodiments taken in conjunction with the accompanying drawings, in which:

FIG. 1 is a table showing synchronous connection-less (SCO) links of a Bluetooth system;

FIG. 2 is a diagram illustrating a conventional Bluetooth system;

FIG. 3 is a diagram depicting a Bluetooth system in accordance with a preferred embodiment of the present invention;

FIGS. 4A and 4B are diagrams showing usages of time slots in a conventional Bluetooth system; and

FIGS. 5A and 5B are diagrams showing usages of time slots in a Bluetooth system in accordance with a preferred embodiment of the present invention.

### PREFERRED EMBODIMENT OF THE INVENTION

Other objects and aspects of the invention will become apparent from the following description of the embodiments with reference to the accompanying drawings, which is set forth hereinafter.

The present invention suggests new types of Bluetooth synchronous connection-oriented (SCO) links.

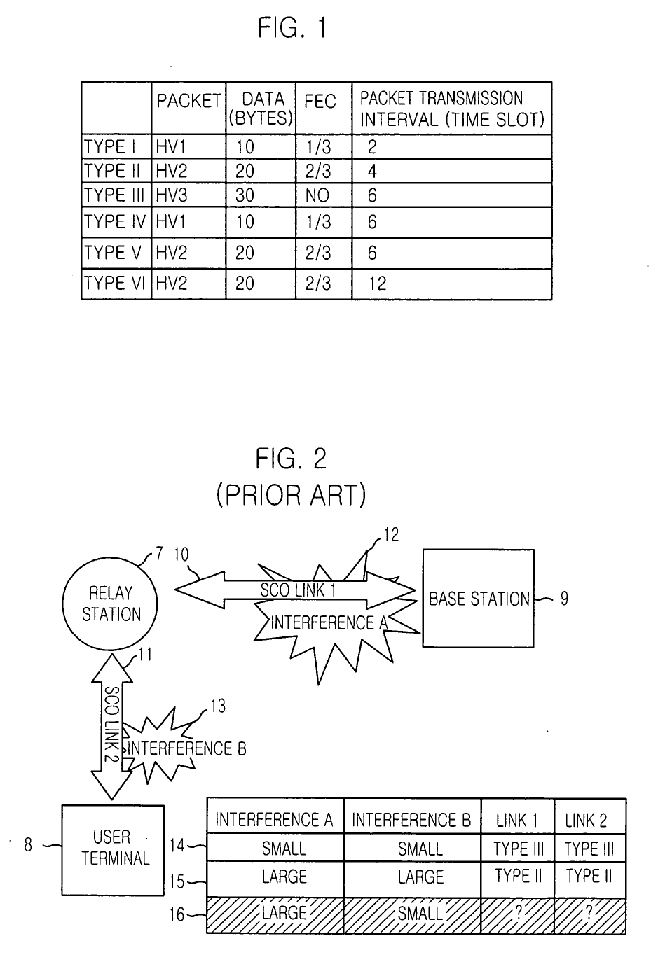

FIG. 1 is a table showing types of SCO links in the conventional Bluetooth standard and types of SCO links in accordance with the present invention. Referring to FIG. 1, types I to III are the types of SCO links in the conventional Bluetooth standard and types IV to VI are the types of SCO links suggested in the present invention.

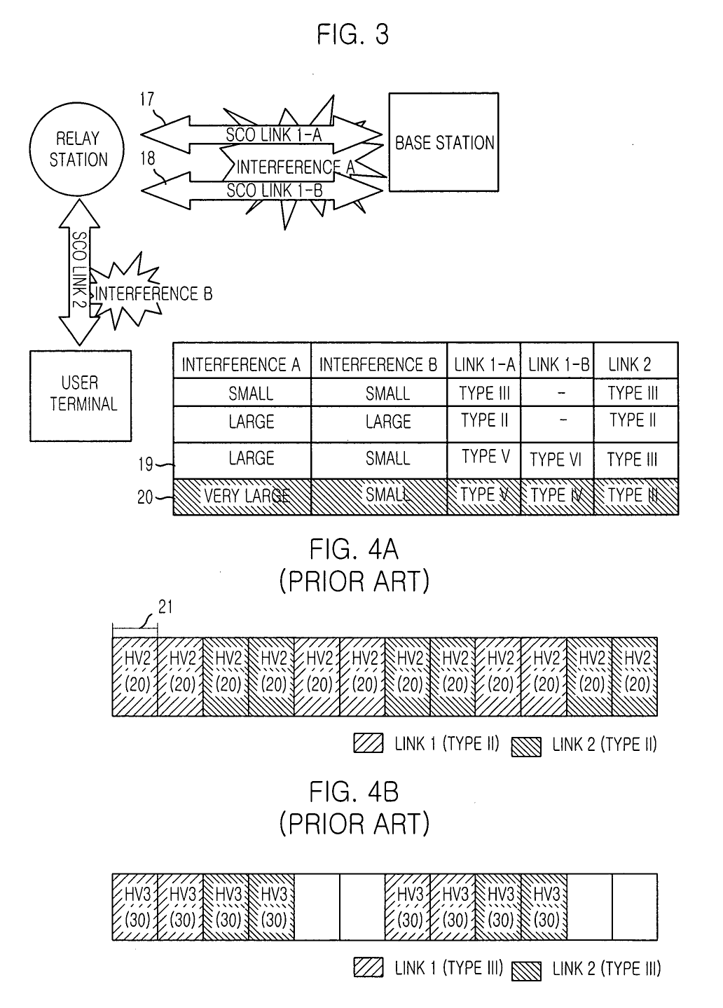

FIG. 3 is a diagram showing a Bluetooth system in accordance with a preferred embodiment of the present invention.

Referring to FIG. 3, an additional SCO link is applied to a link that has larger interference in accordance with a preferred embodiment of the present invention. If interferences A and B are equally small or large, one type of SCO link is applied to the links between Bluetooth devices. It is the initial status that one type of link is chosen for the links between Bluetooth devices.

Then, if interference A is larger than interference B, an additional link is added between the relay station and the base station. Therefore, a link of type V is applied as 1-A link and a link of type VI is applied as 1-B link.

When the interference a gets much larger and higher level of error correction is required comparing to HV2 packet, a link of type IV is applied as SCO link 1-B.

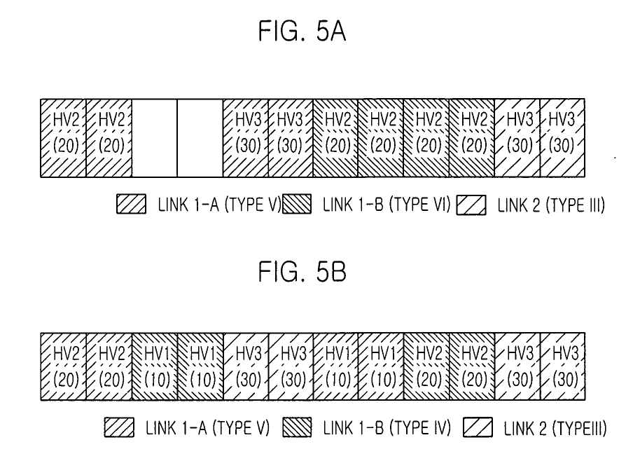

FIGS. 5A and 5B are a diagram showing usages of timeslots in Bluetooth system in accordance with a preferred embodiment of the present invention.

Referring to FIGS. 5A and 5B, the usage of timeslots described in case that the interference of the SCO link I is larger than the interference of the SCO link II and the interference of the SCO link I is much larger than the interference of the SCO link II. Total data rates used in each case are within 64 kbps, i.e., 30 bytes/6 timeslots. That is, the sum of the data rates of the links 1-A and 1-B is within the 64 kbps range.

In case of FIG. 5A, one slot out of six slots has not been used and 17% of energy consumption has been reduced comparing to a case of FIG. 4A, since all timeslots are used in the conventional method in FIG. 4A.

In case of FIG. 5B, the same number of timeslots has been used comparing to FIG. 4A. However, the interference of the channel does not largely affect the quality of data transmission because HV1 packets and HV2 packets have been used together in the system of FIGS. 5A and 5B although only HV2 packets have been used in the system of FIG. 4A.

The method of the present invention can be saved in a computer readable recording medium, e.g., a CD-ROM, a RAM, a ROM, a floppy disk, a hard disk, and an optical magnetic disk.

AS mentioned above, the present invention can reduce the energy consumption of the Bluetooth system while securing quality of data transmission when interference of one link of the Bluetooth system is larger than the other link the Bluetooth system.

Also, if the same amount of energy is used in the Bluetooth system as the conventional Bluetooth system, the present invention can provide higher quality of data transmission than the conventional Bluetooth system.

While the present invention has been shown and described with respect to the particular embodiments, it will be apparent to those skilled in the art that many changes and modifications may be made without departing from the spirit and scope of the invention as defined in the appended claims.

What is claimed is:

1. A method for dynamically and asymmetrically managing synchronous connection-oriented (SCO) links in a Bluetooth system, comprising the steps of:
(a) analyzing a quality of communication channels in the Bluetooth system; and
(b) dynamically changing type of each SCO link according to the channel analysis.

2. The method as recited in claim 1, wherein said step (b) includes the steps of:
(b1) detecting a first channel on which interference is larger than other channel; and
(b2) allocating to the first channel a different type of SCO link from SCO links allocated to the other(s) channels.

3. The method as recited in claim 1, wherein the types of SCO links includes:
a first SCO link using HV1 packet having a packet transmission interval of 6 slots;
a second SCO link using HV2 packet having a packet transmission interval of 6 slots; and
a third SCO link using HV2 packet having a packet transmission interval of 12 slots,
wherein kinds of modified SCO links are not limited to the above SCO links.

4. A computer readable recording medium for recording a program that implements a method for managing SCO links in a Bluetooth system including a microprocessor, the method comprising the steps of:
(a) analyzing a quality of data communication channels in the Bluetooth system; and
(b) changing types of each SCO link according to the channel analysis.
